(19) United States
(12) Patent Application Publication
(10) Pub. No.: US 2026/0166913 A1
(43) Pub. Date: Jun. 18, 2026

(54) Hanger Used to Display Animal Skull

(71) Applicant: Guangzhou Dan'an E-commerce Co., Ltd., Guangzhou (CN)

(72) Inventor: Qiuling Liao, Zhaoqing (CN)

(21) Appl. No.: 19/019,167

(22) Filed: Jan. 13, 2025

(30) Foreign Application Priority Data
Dec. 17, 2024 (CN) 2024231199788

(51) Int. Cl. B44C 5/02; F16M 13/02

(52) U.S. Cl. CPC B44C 5/02; F16M 13/02; F16M 2200/024

(57) ABSTRACT

A hanger used to display an animal skull, includes a fixing plate, a handle and a groove board. The groove board is movably connected to the fixing plate and is provided with a plurality of grooves. The handle is provided with an insert groove matching with the grooves, and the insert groove is fit to clamp in different types of grooves.

### CROSS-REFERENCE TO RELATED APPLICATIONS

The present invention claims the benefit of Chinese Patent Application No. 2024231199788 filed on December 17, 2024, the contents of which are hereby incorporated by reference.

### TECHNICAL FIELD

The present invention belongs to the technical field of hangers and particularly relates to a hanger used to display an animal skull.

### TECHNICAL BACKGROUND

There are two main types of hangers currently used:

(1) Fixed hangers: This type of hanger is fixed to the wall and cannot be rotated or adjusted. That is, the display angle of the animal skull cannot be adjusted, which may result in the details or features of some skulls not being fully displayed;

(2) Rotatable hanger: This type of hanger can rotate horizontally, but cannot adjust the vertical angle. That is, the skull cannot be adjusted according to the characteristics of the skull and the viewer’s perspective. It may not be able to best display the unique features of the skull, affecting the display effect of the skull and failing to meet the needs of multi-angle observation.

### INVENTION CONTENT

In order to overcome the defects of the existing technology, the present invention provides a hanger used to display an animal skull. The hanger has a rotatable groove board and an angle-adjustable handle to meet the needs of users for viewing the animal skull from various angles.

The technical scheme adopted by the invention for solving the technical problems is as follows:

A hanger used to display an animal skull includes a fixing plate, a handle and a groove board. The groove board is movably connected to the fixing plate and is provided with a plurality of grooves. The handle provided with an insert groove matching with the grooves. The insert groove is fit to clamp in different grooves of the groove board.

Further, the groove board is configured as a scallop shape structure, and the groove are evenly distributed on an arc top edge of the groove board.

Further, the groove board is provided with a limited columns, and the handle is provided with a limited grooves. When the insert groove is clamped with the groove, the limited columns are clamped with the limited grooves.

Further, the groove board is hinged to the fixing plate.

Further, a pair of rotary shaft are arranged on a side of the groove board connected to the fixing plate. The fixing plate is correspondingly provided with two shaft holes. The rotary shafts are inserted into the shaft holes, so that the groove board can rotate by the rotary shafts as a supporting point.

Further, an integrally formed bracket is arranged on one side of the handle facing away from the fixing plate, and the bracket is used to support the animal skull.

Further, the bracket includes a left bracket and a right bracket which are symmetrically distributed.

Further, the handle is made of metal material.

Further, the fixing plate is provided with bolt holes.

Further, the groove board is provided with five grooves.

The beneficial effects of the present invention:

The present invention provides a hanger used to display an animal skull, including a fixing plate, a handle and a groove board. The groove board is movably connected to the fixing plate and is provided with a plurality of grooves. The handle is provided with an insert groove matching with the grooves, and the insert groove is fit to clamp in different types of grooves. The present invention provides a plurality of grooves and insert groove for clamping, and the groove board is movably connected to the fixing plate. The combination of the two can not only rotate the groove board, but also adjust the angle of the handle, so as to meet the needs of users to view animal skull from various angles.

### DESCRIPTION OF FIGURES

FIG. 1 is a schematic view of the structure of a hanger used to display an animal skull provided by the present invention;

FIG. 2 is a schematic view of the structure of the fixing plate and the groove board provided by the present invention;

FIG. 3 is a schematic view of the structure of the handle provided in the embodiment I of the present invention;

FIG. 4 is a schematic view of the structure of the handle provided in the embodiment II of the present invention.

Description of marks in figures:

1-fixing plate; 12-shaft hole; 13-bolt hole; 2-groove board; 21-groove; 22-limted column; 23-rotary shaft; 3-handle; 31-bracket; 311-left bracket; 312-right bracket; 32-insert groove; 33-limited groove.

### DETAILED DESCRIPTION OF THE EMBODIMENTS

Below is a further detailed description of the present invention based on the figures.

The present embodiment only shows an explanation of the present invention and it is not a limitation to the present invention. The skilled in the art can make modifications to this embodiment as needed without making any creative contributions after reading this specification, which are always protected by the patent law as long as they are within the scope of the claims of the present invention.

It should be noted that when an element is called as being “fixed to” or “arranged on” another element, it can be directly on the other element or indirectly on the other element. When an element is called as being “connected to” another element, it can be directly connected to the other element or indirectly connected to the other element.

It should be noticed that the terms “length”, “width”, “above”, “below”, “front”, “rear”, “left”, “right”, “vertical”, “horizontal”, “top”, “bottom”, “inside” and “outside” which indicates the orientations or positional relationships are based on the orientations or positional relationships shown in the figures. They are only for facilitating describing the present invention and simplifying the description, rather than indicating or implying that the device or component must have a specific orientation, construct and operate in a specific orientation, therefore, it understood as a limitation of the present invention.

In addition, the terms “first” and “second” are used for descriptive purposes only and cannot be understood as indicating or implying relative importance or implicitly indicating the quantity of indicated technical features. Therefore, a feature defined as “first” and “second” may explicitly or implicitly include one or more of these features. In the description of the present invention, “a plurality of” means two or more, unless otherwise specifically defined.

### Embodiment I

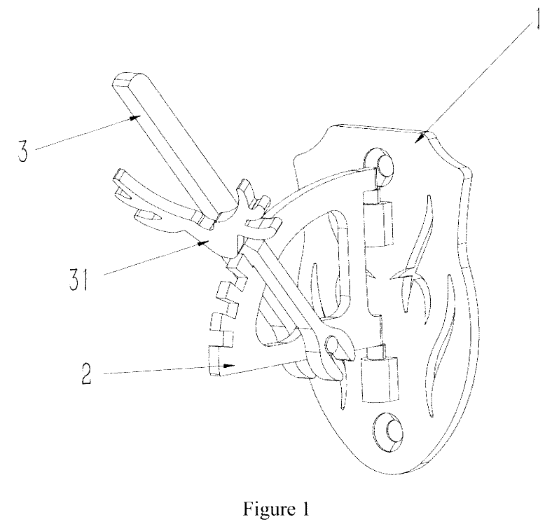

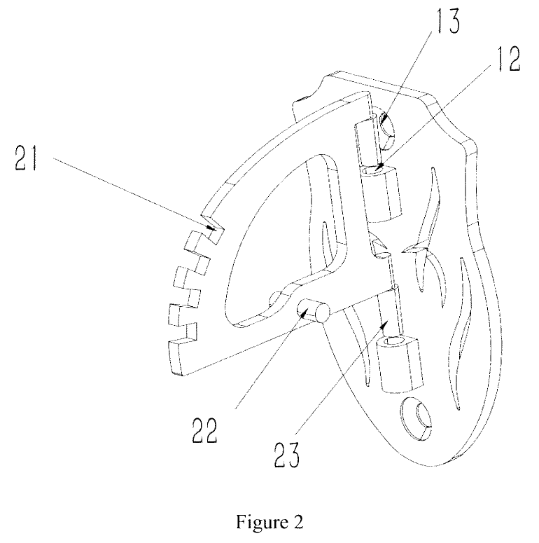

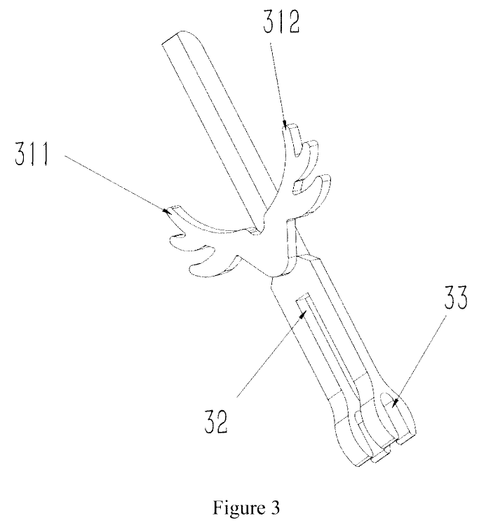

Referring to FIGS. 1-3, this embodiment provides a hanger used to display animal skull, including a fixing plate 1, a handle 3 and a groove board 2. The groove board 2 is movably connected to the fixing plate 1 and is provided with a plurality of grooves 21. The handle 3 is provided with an insert groove 32 matching with the grooves 21. The insert groove 32 is fit to clamp in different grooves 21 of the groove board to fix the handle 3 on the groove board 2.

In this embodiment, the surface where the groove board 2 and the handle 3 are clamped is designed to be arc shape.

Preferably, the groove board 2 is configured as a scallop shape structure, and the grooves 21 are evenly distributed on an arc top edge of the groove board 2.

Further, the groove board 2 is configured as a 90 degree scallop shape structure. In other specific embodiments, the groove board 2 can be configured as other structures such as a semicircle, a trapezoid, etc.

Preferably, the groove board 2 is provided with limited columns 22, and the handle 3 is provided with limited grooves 33. When the insert groove 32 is champed with the groove 21, the limited columns 22 are champed with the limited grooves 33.

In this embodiment, two limited columns 22 are arranged, and the two limited columns 22 are respectively arranged on two sides of the groove board 2. One end of the handle 3 is configured as a U shape structure, and the limited grooves 33 are arranged at two ends of the U shape structure.

In this embodiment, the groove board is provided with five grooves. The insert groove 32 of the handle 3 can be champed to different grooves 21 according to the angle requirements of users.

Preferably, the groove board 2 is hinged to the fixing plate 1. Specifically, a pair of rotary shafts 23 are arranged on a side where the groove board 2 is connected to the fixing plate 1. The fixing plate 1 is correspondingly provided with two shaft holes 12. The rotary shafts 23 are inserted into the shaft holes 12. The groove board 2 rotates by the rotary shafts 23 as a supporting point, thereby realizing a movable connection between the groove board 2 and the fixing plate 1.

In this embodiment, two rotary shafts 23 are arranged on a side where the groove board 2 is connected to the fixing plate 1. Two shaft holes 12 are arranged on the fixing plate 1.

Preferably, an integrally formed bracket 31 is arranged on the side of the handle 3 facing away from the fixing plate 1. The bracket 31 includes a left bracket 311 and a right bracket 312 which are symmetrically distributed. The top of the left bracket 311 and the top of the right bracket 312 enclose to form an arc shape supporting part, which is used to support the animal skull.

In this embodiment, the shape of the bracket 31 formed by the combination of the left bracket 311 and the right bracket 312 is similar to a bilaterally symmetrical deer antler. The arc shape supporting part formed by the left bracket 311 and the right bracket 312 can evenly distribute the weight of the animal skull, thereby ensuring that the animal skull does not move or shake.

Preferably, the handle 3 is made of metal material.

In this embodiment, the handle 3 is made of metal strip material.

Preferably, the fixing plate 1 is provided with bolt holes 13 .

In this embodiment, the fixing plate 1 is usually fixedly connected to the wall. The external bolts are threadedly connected to the bolt holes 13 to fix the position of the fixing plate 1.

The advantages of the hanger provided in this embodiment are:

1. A plurality of grooves 21 are arranged on the groove board 2 to achieve the purpose of adjusting the angle when displaying the animal skull.

2. The groove board 2 is rotatably connected to the fixing plate 1, so as to achieve the purpose of rotating the animal skull when displaying the animal skull.

3. An integrally formed bracket 31 is arranged on the handle 3 to ensure that the animal skull does not move or shake when displaying the animal skull.

### Embodiment II

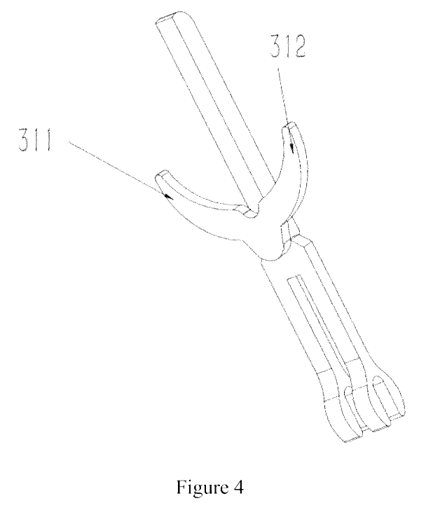

Referring to FIG. 4, the difference between embodiment II and embodiment I is that the shape of the bracket 31 formed by the combination of the left bracket 311 and the right bracket 312 in embodiment II is similar to a bilaterally symmetrical sheep horn. The two ends of the left bracket 311 and the right bracket 312 jointly support the animal skull, so that the weight of the animal skull is evenly distributed, ensuring that the animal skull does not move or shake.

The remaining features and advantages of embodiment II are the same as those of embodiment I.

It could be understood that under the guidance of the above embodiments, those skilled in the filed can combine various implementation methods in the above embodiments to obtain technical solutions of multiple implementation methods.

The above description is only a preferred embodiment of the present invention and is not to limit the present invention. Any modifications, equivalent substitutions and improvements made within the spirit and principles of the present invention should be included in the protection scope of the present invention.

What is claimed is:

1. A hanger used to display an animal skull, comprises a fixing plate, a handle and a groove board, wherein the groove board is movably connected to the fixing plate and is provided with a plurality of grooves; the handle is provided with an insert groove matching with the grooves; and the insert groove is fit to clamp in different grooves of the groove board.

2. The hanger used to display an animal skull according to claim 1, wherein the groove board is configured as a scallop shape structure, and the grooves are evenly distributed on an arc top edge of the groove board.

3. The hanger used to display an animal skull according to claim 1, wherein the groove board is provided with limited columns, and the handle is provided with limited grooves; when the insert groove is clamped in the groove, the limited columns are clamped in the limited grooves.

4. The hanger used to display an animal skull according to claim 1, wherein the groove board is hinged to the fixing plate.

5. The hanger used to display an animal skull according to claim 4, wherein a pair of rotary shafts are arranged on a side of the groove board connected to the fixing plate; the fixing plate is correspondingly provided with two shaft holes; the rotary shafts are inserted into the shaft holes; and the groove board rotates by the rotary shafts as a supporting point.

6. The hanger used to display animal skull according to claim 1, wherein an integrally formed bracket is arranged on one side of the handle facing away from the fixing plate, and the bracket is used to support the animal skull.

7. The hanger used to display animal skull according to claim 6, wherein the bracket comprises a left bracket and a right bracket which are symmetrically distributed.

8. The hanger used to display animal skull according to claim 1, wherein the handle is made of metal material.

9. The hanger used to display animal skull according to claim 1, wherein the fixing plate is provided with bolt holes.

10. The hanger used to display animal skull according to claim 1, wherein the groove board is provided with five grooves.
